(19) United States
(12) Patent Application Publication
(10) Pub. No.: US 2012/0057343 A1
(43) Pub. Date: Mar. 8, 2012

(54) ILLUMINATING APPARATUS HAVING HEAT DISSIPATION BASE AND MULTILAYER ARRAY-TYPE LED MODULE

(75) Inventors: Jon-Fwu Hwu, Hsinchu County (TW); Yung-Fu Wu, Hsinchu County (TW); Kui-Chiang Liu, Hsinchu County (TW)

(73) Assignee: GEM WELTRONICS TWN CORPORATION, Hsinchu County (TW)

(21) Appl. No.: 12/876,389

(22) Filed: Sep. 7, 2010

(51) Int. Cl. F21V 5/00; F21V 7/00

(52) U.S. Cl. 362/235

(57) ABSTRACT

An illuminating apparatus having a heat dissipation base and a multilayer array-type LED module is provided. The multilayer array-type LED module serves as a light source, and a heat dissipation element is provided. The multilayer array-type LED module is featured with a high luminescent efficiency and consumes less power, and the heat dissipation element is adapted for dissipating the heat generated by the multilayer array-type LED module by natural air convection. The combination of the multilayer array-type LED module and the heat dissipation element achieves a better performance of the illuminating apparatus, and can be conveniently further combined with other lamps, or even customized for satisfying different requirements and demands.

### BACKGROUND OF THE INVENTION

1. Field of the Invention

The present invention relates generally to an illuminating apparatus, and more particularly to an illuminating apparatus having a heat dissipation base and a multilayer array-type LED module.

2. The Prior Arts

Illuminating apparatuses are necessary for people's daily life, and have even changed people's lifestyle. For example, many different kinds of illuminating apparatuses including fluorescent lamps, illuminating lamps, reading lamps, chandeliers, and neon lamps, are employed in most of current homes or public indoor places for improving the convenience of human activity in the darkness.

Generally, different illuminating apparatuses are used for different purposes. For example, typical fluorescent lamps, illuminating lamps, and reading lamps are usually applied for general illumination purpose. However, some other specifically designed illuminating apparatuses, e.g., night-lights, are used to provide auxiliary illumination when people are asleep. When conventional lamp bulbs and fluorescent tubes are in use, they usually disadvantageously increase temperature fast and consume more power. When they are discarded, they also cause pollution or related environmental protection problems. As such, serving as an upgraded light source, light emitting diode (LED) recently becomes an important technology.

Although it is well known that LEDs have the advantages of low power consumption, long lifespan, and no need to warm up, the luminance of ordinary LEDs are usually lower than conventional lamp bulbs and fluorescent tubes. Therefore, high-power LEDs are more often adopted for serving as illuminating light sources. Although high-power LEDs are capable of providing higher luminance, when a high-power LED is consecutively in operation, the operation temperature thereof is usually very high, which adversely affect the luminescent efficiency of the high-power LED. Accordingly, it is an important concern to improve the heat dissipation of LEDs for achieving an improved illumination performance.

### SUMMARY OF THE INVENTION

Accordingly, a primary objective of the present invention is to provide an illuminating apparatus having a heat dissipation base and a multilayer array-type LED module. The multilayer array-type LED module serves as a light source, and a heat dissipation element is provided. The multilayer array-type LED module is featured with a high luminescent efficiency and consumes less power, and the heat dissipation element is adapted for dissipating the heat generated by the multilayer array-type LED module by natural air convection. The combination of the multilayer array-type LED module and the heat dissipation element achieves a better performance of the illuminating apparatus, and can be conveniently further combined with other lamps, or even customized for satisfying different requirements and demands.

For achieving the foregoing objective and others, the present invention provides an illuminating apparatus including a heat dissipation base, at least one LED module, an embedding board, and a lens.

The heat dissipation base is adapted for being assembled with a lamp element. The heat dissipation base includes an accommodating slot and a plurality of heat dissipation through holes distributed around the accommodating slot. The heat dissipation through holes are configured through the heat dissipation base along at least a horizontal direction and a vertical direction, respectively. The heat dissipation through holes configured through the heat dissipation base along the horizontal direction are preferably communicated with the heat dissipation through holes configured through the heat dissipation base along the vertical direction.

The LED module is mounted on a surface of the accommodating slot. The embedding board is embedded inside the accommodating slot and is secured to the heat dissipation base. The embedding board includes at least one opening portion having an opening. The opening is configured positionally corresponding to the LED module for accommodating the LED module therein. A top side of the opening portion is distant from the surface of the heat dissipation base and configures an embedding slot thereby. The lens is embedded inside the embedding slot.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an exploded view of the illuminating apparatus according to an embodiment of the present invention;

FIG. 2 is a perspective view of the illuminating apparatus according to an embodiment of the present invention;

FIG. 3 illustrates a first embodiment of the present invention;

FIG. 4 illustrates a second embodiment of the present invention;

FIG. 5 illustrates an operational status of the illuminating apparatus according to an embodiment of the present invention; and

FIG. 6 illustrates a further operational status of the illuminating apparatus according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

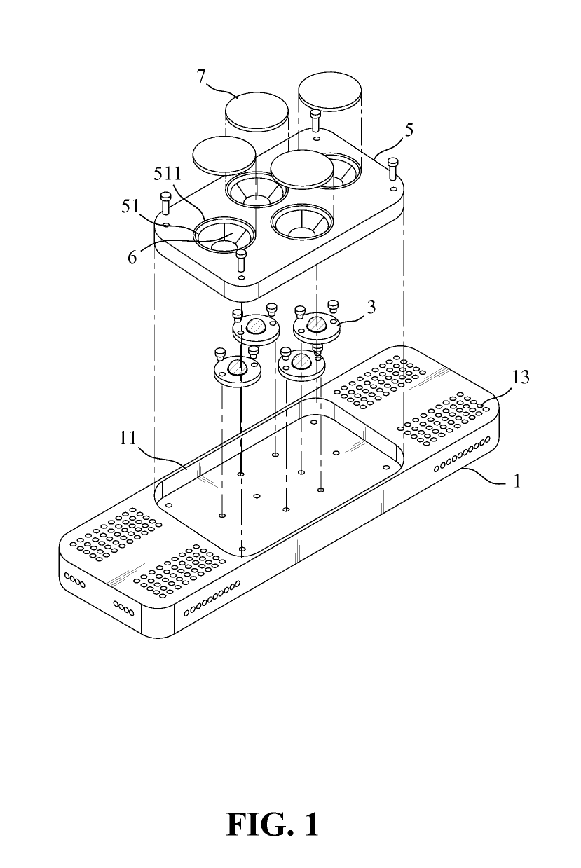

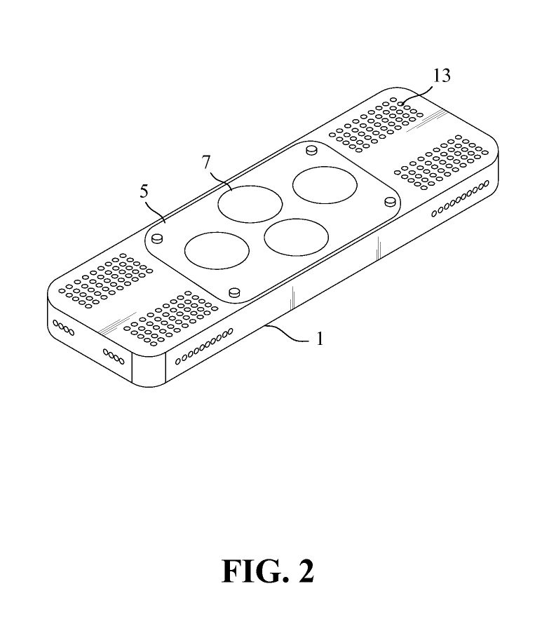

FIG. 1 is an exploded view of the illuminating apparatus according to an embodiment of the present invention. FIG. 2 is a perspective view of the illuminating apparatus according to an embodiment of the present invention. Referring to FIGS. 1 and 2, the illuminating apparatus includes at least one heat dissipation base 1, at least one LED module 3, an embedding board 5, and a lens 7.

The heat dissipation base 1 is configured with a cubical form, and is adapted for being assembled with a lamp element. The heat dissipation base 1 includes an accommodating slot 11, and a plurality of heat dissipation through holes 13 distributed around the accommodating slot 11. As shown in FIG. 1, the accommodating slot 11 is configured at a central area of the heat dissipation base 1. However, it should be noted that the position of the accommodation slot 11 shown in FIG. 1 is for illustration purpose only, and is not for restricting the scope of the present invention. The heat dissipation through holes 13 are configured through the heat dissipation base 1 along at least a horizontal direction and a vertical direction, respectively. The heat dissipation through holes 13 configured through the heat dissipation base 1 along the horizontal direction are preferably communicated with the heat dissipation through holes 13 configured through the heat dissipation base 1 along the vertical direction. In other embodiments, the heat dissipation through holes 13 can also be diagonally intersected and communicated.

The LED module 3 is mounted on a surface of the accommodating slot 11. The LED module 3 serves as a light source, which can be driven by a power supply for emitting light. As shown in FIG. 1, the LED module 3 is constituted of four LEDs arranged in an array and uniformly distributed on the surface of the accommodating slot 11. Such an arrangement is adapted for efficiently increasing the luminance and illuminating range. It should be noted that the number and the distribution of the LEDs shown in FIG. 1 are for exemplification purpose only without restricting the scope of the present invention.

The embedding board 5 is embedded inside the accommodating slot 11 and is secured to the heat dissipation base 1. As exemplified in FIG. 1, the embedding board 5 is secured to the heat dissipation base 1 in a locking manner. Preferably, the embedding board 5 has a size and shape corresponding to the accommodating slot 11. The embedding board 5 includes at least one opening portion 51 having an opening. The opening portion 51 is cone-shaped which lower side is smaller than its upper side. The opening is configured positionally corresponding to the LED module 3 for accommodating the LED module 3 therein. For example, in accordance with the embodiment as shown in FIG. 1, the embedding board 5 includes four opening portions 51 corresponding to the four LED modules 3. Each LED module 3 is enclosed in an opening of a corresponding opening portion 51.

A top side of the opening portion 51 is distant from the surface of the heat dissipation base and configures an embedding slot 511 thereby. According to an aspect of the embodiment, at least one reflective shield 6 is provided on an inner wall of each opening portion 51 for achieving an improved light reflecting or mixing performance. The lens 7 is embedded inside the embedding slot 511.

When the LED module 3 emit light, a part of the light is directly projected out, and the rest of the light is reflected by the inner wall of the opening portion 51 so as to concentrate in a predetermined space, thus improving the luminance and uniformity and generating a bright and soft light source.

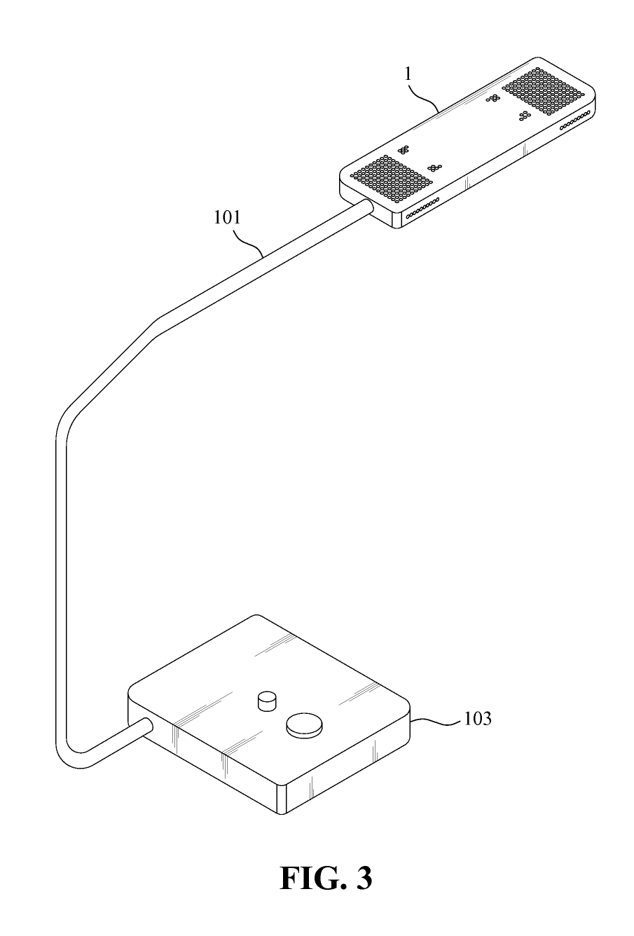

FIG. 3 illustrates a first embodiment of the present invention. The illuminating apparatus of the present invention can be applied in a variety of lamps. As shown in FIG. 3, there is shown a height-adjustable reading lamp further developed from the illuminating apparatus as illustrated above. Referring to FIG. 3, the heat dissipation base 1 is further configured with an assembly hole (not shown in the drawings) at one side thereof. The assembly hole can be used to assembly with one end of a bendable lamp pole 101. Another end of the bendable lamp pole 101 is assembled with a lamp stand 103. The user can adjust the height of the illuminating apparatus by bending the bendable lamp pole 101.

When the LED module 3 emits light, the heat generated thereby is absorbed by the heat dissipation base 1 at first, and then carried away by the air flow flowing by the heat dissipation through holes 13, and then dissipated in the environment by air convection. Such a heat dissipation approach not only is environmental friendly, but also saves raw material cost. The heat dissipation base 1 helps to dissipate the heat generated by the LED module 3, and allowing the LED module 3 working under a relative low temperature, such that the LED module 3 can work in an optimal condition for a longer lifespan.

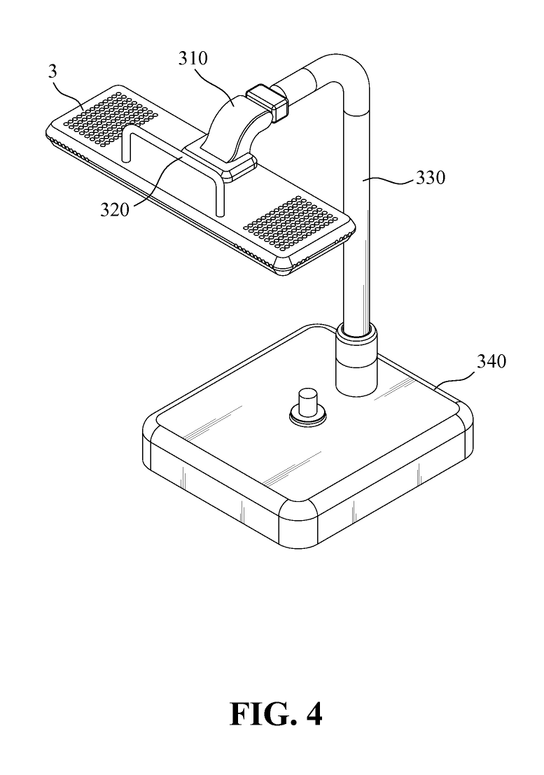

FIG. 4 illustrates a second embodiment of the present invention. As shown in FIG. 4, there is shown an angle-adjustable reading lamp further developed from the illuminating apparatus as illustrated above. Referring to FIG. 4, a backside of the heat dissipation base 1 is assembled to one end of a bendable adjustment element 310. A reverse U-shaped handle 320 is further provided on the backside of the heat dissipation base 1. Another end of the bendable adjustment element 310 is assembled to one end of an L-shaped lamp pole 330, and another end of the L-shaped lamp pole 330 is secured to a lamp stand 340. The user can adjust the light outputting angle of the illuminating apparatus by adjusting the handle 320.

In accordance with the embodiments as illustrated in FIGS. 3 and 4, it can be learnt that the illuminating apparatus of the present invention is adapted for serving as illuminating light sources of lamps, or auxiliary light sources of electronic equipment. Further, facilitated with the optical reflection provided by the reflective shield 6, the LED modules 3 distributed in an array form are adapted for effectively controlling the luminance and the hue of the emitted light.

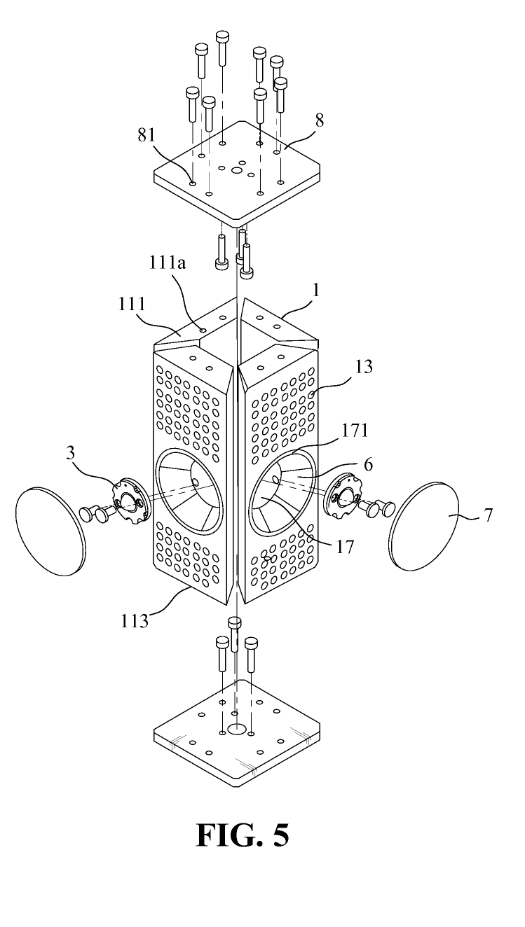

FIG. 5 illustrates an operational status of the illuminating apparatus according to an embodiment of the present invention. Referring to FIG. 5, the illuminating apparatus includes a plurality of heat dissipation bases 1 and two retaining plates 8. Each heat dissipation base 1 is configured with a cubical shape preferably having a trapezoidal cross-section. The heat dissipation bases 1 are assembled to constitute a polygonal pillar structure. As shown in FIG. 5, the present invention is exemplified with a quadrilateral pillar structure constituted of four heat dissipation bases 1. Each heat dissipation base 1 has an upper end surface 111 and a lower end surface 113. Each of the upper end surface 111 and the lower end surface 113 has at least one locking hole 111a. It should be noted that the shape of the heat dissipation base 1 and the number of the locking hole 111a exemplified in FIG. 5 are given for illustration purpose only, and are not to restrict the scope of the present invention.

The two retaining plates 8 are locked to the upper end surface 111 and the lower end surface 113, respectively, for assembling and securing the heat dissipation base 1. Each retaining plate 8 is configured with a plurality of through holes 81. Each of the through holes 81 is positionally corresponding to one of the locking holes 111a of the heat dissipation bases 1 for locking with the corresponding heat dissipation base 1 thereby. The two retaining plates 8 are adapted for jointly securing at least one lamp element.

Each heat dissipation base 1 has a light outputting surface positioned for outwardly projecting a light. The light outputting surface includes a light outputting slot 17. The light outputting slot 17 is configured with a cone shape or other suitable shapes. Preferably, the light outputting slot 17 is positioned at a central area of the heat dissipation base 1. An upper surface of the light outputting slot 17 is distant from the light outputting surface for a certain distance, which configures an embedding slot 171. The heat dissipation base 1 further includes a plurality of heat dissipation through holes 13 distributed around the light outputting slot 17. The heat dissipation through holes 13 are configured through the heat dissipation base 1 along at least a horizontal direction and a vertical direction, respectively. The heat dissipation through holes 13 configured through the heat dissipation base 1 along the horizontal direction are preferably communicated with the heat dissipation through holes 13 configured through the heat dissipation base 1 along the vertical direction. In other embodiments, the heat dissipation through holes 13 can also be diagonally intersected and communicated.

At least one LED module 3 is mounted on a bottom of the light outputting slot 17. The LED module 3 serves as a light source, which can be driven by a power supply for emitting light. As shown in FIG. 5, at least one reflective shield 6 is provided on an inner wall of each light outputting slot 17 for achieving an improved light reflecting or mixing performance. The lens 7 is embedded inside the embedding slot 171.

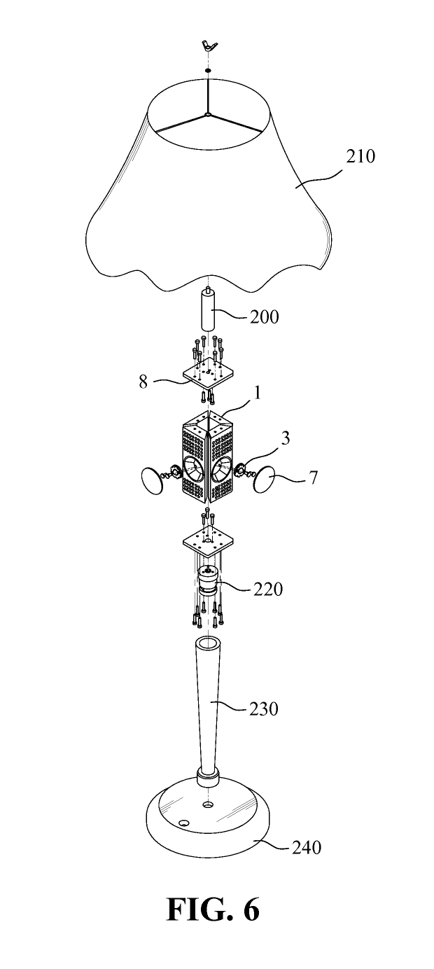

FIG. 6 illustrates a further operational status of the illuminating apparatus according to an embodiment of the present invention. The illuminating apparatus as shown in FIG. 5 of the present invention can be applied in a variety of lamps. As shown in FIG. 6, there is shown a table lamp. However, it should be noted that the table lamp is provided for exemplification purpose only without restricting the scope of the present invention. Referring to FIG. 6, the retaining plate 8 positioned at the upper side of the heat dissipation bases 1 is further assembled to a bottom end of an upper pole 200. A top end of the upper pole 200 is coupled to a lamp shield 210. The retaining plate 8 positioned at the bottom side of the heat dissipation bases 1 is further locked to a top end of a locking bar 220. A bottom end of the locking bar 220 is secured to a top end of a lower pole 230. A bottom end of the lower pole 230 is secured to the lamp stand 240.

When the LED modules 3 emit light, the light is 360° transmitted outwardly. In fact, the numbers of heat dissipation bases 1 and the LED modules 3 can be varied in accordance with the practical demand.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An illuminating apparatus, comprising:
at least one heat dissipation base, adapted for being assembled with a lamp element, the heat dissipation base comprising an accommodating slot and a plurality of heat dissipation through holes distributed around the accommodating slot, wherein the heat dissipation through holes are configured through the heat dissipation base along at least a horizontal direction and a vertical direction, respectively, and the heat dissipation through holes configured through the heat dissipation base along the horizontal direction are communicated with the heat dissipation through holes configured through the heat dissipation base along the vertical direction;
at least one LED module, mounted on a surface of the accommodating slot;
an embedding board, embedded inside the accommodating slot and secured to the heat dissipation base, the embedding board comprises at least one opening portion having an opening positionally corresponding to the LED module for accommodating the LED module therein, wherein an embedding slot is configured between an upper surface of the opening portion and the surface of the heat dissipation base; and
a lens, embedded in the embedding slot.

2. The illuminating apparatus as claimed in claim 1, wherein the heat dissipation through holes are diagonally intersected and communicated.

3. The illuminating apparatus as claimed in claim 1, wherein the at least one LED module is plural and distributed in an array type on the surface of the accommodating slot.

4. The illuminating apparatus as claimed in claim 1, wherein a reflective shield is provided on an inner wall of each opening portion.

5. An illuminating apparatus, comprising:
a polygonal shaped pillar constituted of a plurality of heat dissipation bases, each of the heat dissipation bases comprising an upper end surface and a lower end surface, and each of the upper end surface and the lower end surface comprising a locking hole, wherein each heat dissipation base comprises a light outputting surface facing outwardly, and a light outputting slot configured at the light outputting surface, wherein an embedding slot is configured between an upper surface of the light outputting slot and the surface of the heat dissipation base, wherein the heat dissipation base comprising a plurality of heat dissipation through holes distributed around the light outputting slot, wherein the heat dissipation through holes are configured through the heat dissipation base along at least a horizontal direction and a vertical direction, respectively, and the heat dissipation through holes configured through the heat dissipation base along the horizontal direction are communicated with the heat dissipation through holes configured through the heat dissipation base along the vertical direction;
two retaining plates, adapted for assembling to secure the heat dissipation bases, wherein each retaining plate comprises a plurality of through holes, each of the through holes is positionally corresponding to one of the locking hole of the heat dissipation bases for locking with the corresponding heat dissipation base thereby, and the two retaining plates are adapted for jointly securing at least one lamp element thereto;
at least one LED module, mounted on a bottom of the light outputting slot; and
a lens, embedded in the embedding slot.

6. The illuminating apparatus as claimed in claim 5, wherein the heat dissipation through holes are diagonally intersected and communicated.

7. The illuminating apparatus as claimed in claim 5, wherein the at least one LED module is plural and distributed in an array type on the bottom of the light outputting slot.

8. The illuminating apparatus as claimed in claim 5, wherein a reflective shield is provided on an inner wall of each light outputting slot.

9. The illuminating apparatus as claimed in claim 5, wherein the heat dissipation base is configured with a cubical shape having a trapezoidal cross-section.
